(19) United States
(12) Patent Application Publication
(10) Pub. No.: US 2026/0324552 A1
(43) Pub. Date: Oct. 22, 2026

(54) DOCK-BASED WEED CONTROL

(71) Applicant: Anthony G. Roller, Bloomington, MN (US)

(72) Inventor: Anthony G. Roller, Bloomington, MN (US)

(21) Appl. No.: 19/181,496

(22) Filed: Apr. 17, 2025

(51) Int. Cl. A01D 44/00

(52) U.S. Cl. CPC A01D 44/00

(57) ABSTRACT

Dock-based weed control is described herein. One example system includes a channel configured to extend along a dock section, the channel having a proximal end and a distal end, a bracket configured to reciprocatively translate along the channel between the proximal end and the distal end, a motor configured to drive the reciprocal translation of the bracket, a leg component connected to the bracket, and a roller connected to a bottom end of the leg component.

### TECHNICAL FIELD

The present disclosure relates generally to dock-based weed control.

### BACKGROUND

The rapid growth of underwater weeds can prevent the enjoyment of lakes, ponds, streams, and other bodies of water. Underwater plant life, frequently rooted in the bottom of a body of water, interferes with swimming, boating and other water-related activities.

### BRIEF DESCRIPTION OF THE DRAWINGS

The detailed description references the accompanying figures. The use of the same reference numbers in different instances in the description and the figures may indicate similar or identical items. In addition, the proportion and the relative scale of the elements provided in the figures are intended to illustrate various embodiments of the present disclosure and are not to be used in a limiting sense.

FIG. 1 is a cross-sectional side view of a dock-based weed control system 100 in accordance with a number of embodiments of the present disclosure.

FIG. 2 is an overhead view of a dock-based weed control system 100 in accordance with a number of embodiments of the present disclosure.

FIG. 3 is another overhead view of a dock-based weed control system 100 installed on a dock system in accordance with a number of embodiments of the present disclosure.

### DETAILED DESCRIPTION

The present disclosure relates to the removal of underwater plant life from the bottom of a body of water. More specifically, the present invention relates to a weed remover that rolls on the bottom of a body of water, removing existing underwater plant life and preventing the growth of new underwater plant life.

Some previous attempts to remove underwater plant life from the bottom of a body of water have focused on cutting grown weeds with various cutting implements such as underwater rakes, chains, and other sharp devices. These devices attempt to cut or pull out the underwater weeds so that they can be removed and no longer interfere with water activities. See, e.g., Farmer U.S. Pat. No. 3,133,395, Kriger U.S. Pat. No. 4,999,982, and Roth U.S. Pat. No. 5,074,105.

A problem with such cutting implements is that the focus is on cutting or uprooting the weeds rather than preventing their growth. After cutting the weeds, the weeds often grow back so that the process must be constantly repeated to insure a weed-free environment. In addition, the above-mentioned devices often require the use of manual labor to cut and remove the weeds.

Other previous approaches utilize an elongated horizontal roller that pivots at one end about a vertical axis, thereby creating a semicircular region of weed removal (e.g., Majkrzak, U.S. Pat. No. 5,359,835). Such approaches carry a few shortcomings. For instance, the roller, being affixed and driven by a motor only at one end, may be limited in its effective area by the stresses such an arrangement places on the roller components and on the motor. These approaches may additionally suffer from ineffectiveness where the depth of the bottom of the body of water is uneven.

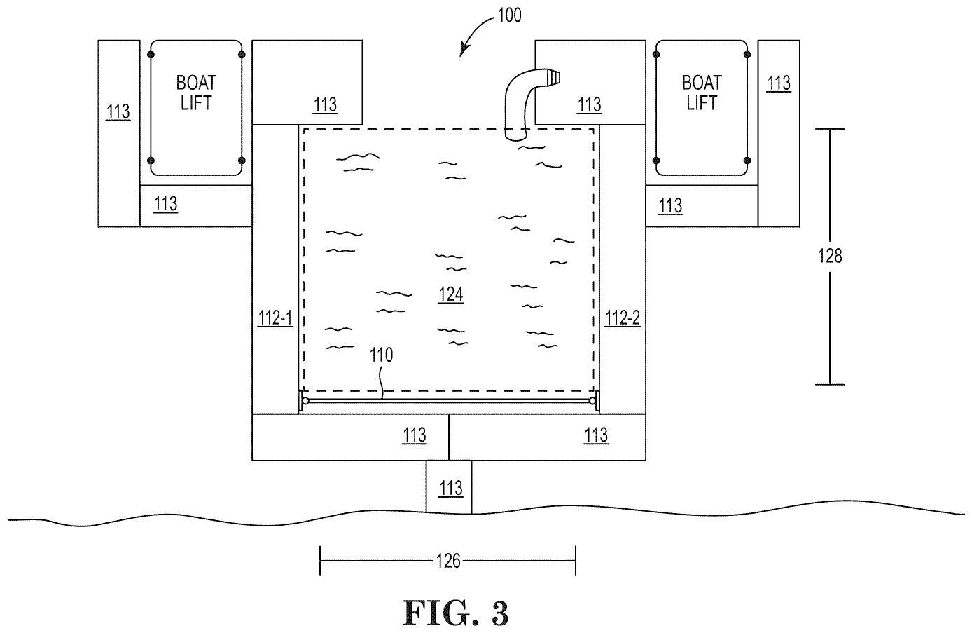

Many modern docks are available in a “U” or “Y” shaped configuration, in which two dock sections, separated by some distance, extend in a substantially parallel direction out into the body of water (see, e.g., FIG. 3, discussed further below). These configurations are increasing in popularity because, among other things, they provide a discrete and protected area between the two dock sections for swimming and/or mooring. They may be especially desirable for parents of younger children because the children can be corralled by the dock sections and kept under supervision. However, the typically rectangular shape of these areas is not well suited for products that provide a semicircular region of weed removal. A dock owner could even elect to incur the onerous costs of employing multiple pivoting weed removers in such an area and still be frustrated by weeds that a pivoting approach simply cannot reach.

The present invention provides an underwater weed remover which removes and prevents the growth of plant life on the bottom of a body of water by reciprocatively translating a cylindrical roller over a portion of the bottom. In some embodiments, the roller rotates about an axle that is attached at each end to a respective leg component. The leg components can be weighted, spring-loaded, or otherwise configured to cause the roller to apply a downward force on the bottom of the body of water. Each of the leg components can be connected to a bracket that can translate (e.g., slide) along a channel that extends along a dock section. The translation of the legs and the roller can be driven by one or more motors associated with each end of the roller. Embodiments of the present disclosure include a roller that is supported and driven at each of its ends, which reduces the torsional stresses seen in single-motor approaches. Additionally, in contrast to previous approaches, embodiments herein can reduce (e.g., eliminate) weed growth in rectangular areas.

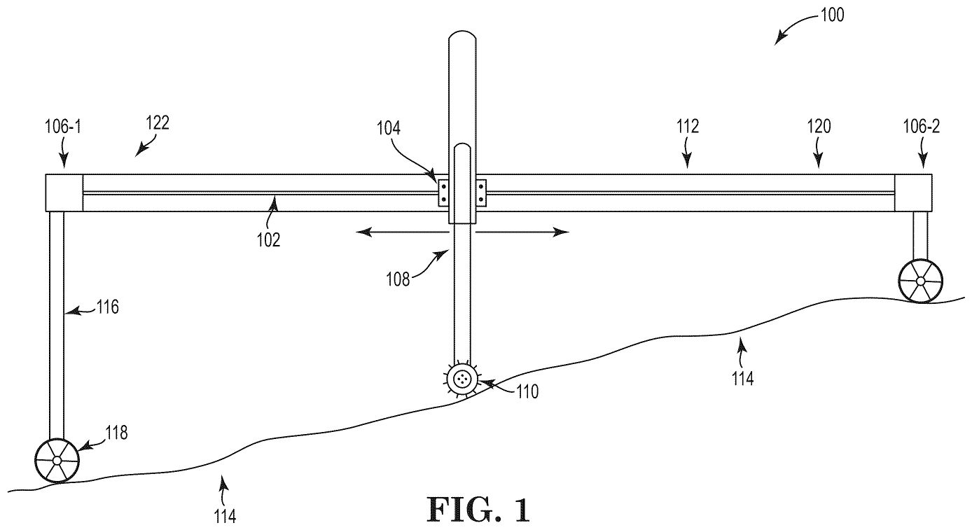

FIG. 1 is a cross-sectional side view of a dock-based weed control system 100 in accordance with a number of embodiments of the present disclosure. As illustrated in FIG. 1, the example system 100 includes a channel 102, a bracket 104, a first motor 106-1, a second motor 106-2, a leg component 108, and a roller 110.

The channel 102 is an elongated opening (e.g., groove), and can be of a suitable height and/or depth. In some embodiments, the channel 102 is formed by removing material from a larger member made of a suitable material, such as steel, aluminum, or a polymeric material, for instance, though embodiments herein are not so limited. In some embodiments, the channel is formed by bending or otherwise deforming opposing edges of a material toward each other.

The channel 102 includes a proximal end 120 and a distal end 122. The channel 102 can be affixed to a dock (e.g., dock section 112). The channel 102 can be affixed using a plurality of bolts, for instance, though embodiments herein are not so limited. The proximal end 120 of the channel 102 can correspond to a proximal end of the dock section 112, and the distal end 122 of the channel 102 can correspond to a distal end of the dock section 112.

While the present disclosure makes reference to docks and dock sections, it is to be understood that embodiments herein are not so limited. A channel 102 can be affixed to any suitable structure permanently or temporarily located adjacent to an area where weed control is desired. Such structures can include walls, posts, pilings, piers, boat hoists, shorelines, jetties, dams, wharfs, etc. As shown in the example illustrated in FIG. 1, the dock section 112 is a portion of a rolling dock and includes wheels 118 located at the bottom ends of distal dock legs 118. However, embodiments of the present disclosure may be installed on permanent structures, floating structures, submerged structures, and others.

A height of the channel 102 can vary across its depth. For instance, the channel 102 can include one or more lips or flanges such that a portion of the bracket 104 (discussed below) is retained within the channel 102. In some embodiments, the top and/or bottom of the channel 102 is substantially flat. In some embodiments, the top and/or bottom of the channel 102 is radiused or rounded (e.g., cup shaped). In some embodiments, the top and/or bottom of the channel 102 includes a rail. The bottom of the channel 102 may be provided with one or more openings allowing water, sand, silt, vegetation, and/or other detritus to drain.

The bracket 104 connects the leg component 108 to the channel 102. The bracket 104 can include a protrusion configured to be retained within the channel 102, and allow the bracket 104 to reciprocatively translate through the channel 102. In some embodiments, the bracket 104 is configured to slide through the channel 102 reciprocatively from the proximal end 120 to the distal end 122. In some embodiments, the bracket 104 includes one or more rotating components (e.g., wheels, rollers, bearings, etc.) configured to rotate within the channel 102 and reduce friction between the bracket 102 and the channel 102 as the bracket 104 reciprocatively translates from the proximal end 120 to the distal end 122. The rotating components may be sized to allow rotation within the channel 102 while preventing withdrawal of the bracket 104 from the channel 102.

The leg component 108, as shown in FIG. 1, can be substantially vertical and is slidably connected to the bracket 104. A vertical position of the leg component 108 (and the roller 110) can vary according to a slope of the bottom of the body of water. In some embodiments, like that shown in the example illustrated in FIG. 1, the leg component 108 slides upwards and downwards within a housing (e.g., tube, sleeve, etc.) of the bracket 104. In other embodiments, the leg component 108 slides upwards and downwards within one or more collars or rings. The leg component 108 and/or the bracket 104 can include a locking component configured to fix the leg component 108 in a vertical position with respect to the bracket 104. Such a component can include a pin, collar, set screw, etc., though embodiments herein are not so limited. The leg component 108 can be weighted or spring-loaded to provide increased downward force. In some embodiments, the leg component 108 can be selectively rotated (e.g., to a substantially horizontal position) via a rotational component on the bracket 104. For storage or maintenance, for instance, the leg component 108 can be rotated such that it is held substantially parallel with the channel 102.

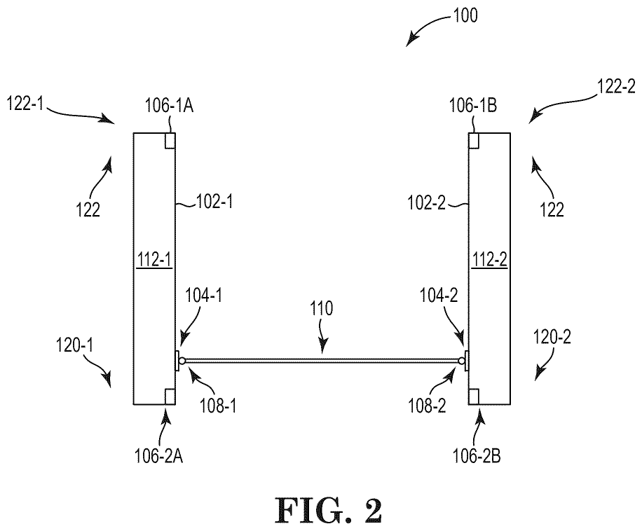

The roller 110 can be a cylinder and can include a plurality of radially extending fins spaced from each other radially and spaced along the length of the roller 110. The roller 110 can be hollow or solid. In some embodiments, the roller 110 rotates about an axle that extends from the leg component 108 to another leg component (illustrated below in FIGS. 2 and 3).

As shown in the example illustrated in FIG. 1, the system 100 can include a first motor 106-1 and a second motor 106-2 (sometimes cumulatively referred to as “motors 106”). Embodiments herein are not limited to a particular quantity of motors. In some embodiments, for instance, four motors may be used. The motors 106 can be located at opposing ends of the channel 102. In some embodiments, a single motor 106 may be associated with the channel 102. The motors 106 can be mounted to a sidewall or to underside of the dock section 112.

The motors 106 can be any suitable type of motor and can operate to reciprocatively translate the bracket 104 through the channel 102. The motors 106 can drive the bracket using a belt, a chain, or by any suitable mechanism. The motors 106 can be operated via a controller. The controller can receive inputs from an interface coupled to one or more of the motors 106. The controller can receive inputs from a mobile device wirelessly coupled to the controller (e.g., via a mobile application). The motors 106 can be operated automatically at preselected times through the use of a timer.

FIG. 2 is an overhead view of a dock-based weed control system 100 in accordance with a number of embodiments of the present disclosure. As illustrated in FIG. 1, the example system 100 includes a first dock section 112-1 associated with first channel 102-1, a first bracket 104-1, a first motor 106-1A, a second motor 106-2A, and a first leg component 108-1. The example system 100 further includes a roller 110, and a second dock section 112-2 associated with a second channel 102-2, a second bracket 104-2, a third motor 106-1B, a fourth motor 106-2B, and a second leg component 108-2.

Operation of the first motor 106-1A and the second motor 106-2A causes the first bracket 104-1 and the first leg 108-1 to travel from the proximal end 120-1 of the first channel 102-1 to the distal end 122-1 of the first channel 102-1. Simultaneously, operation of the third motor 106-1B and the fourth motor 106-2B causes the second bracket 104-2 and the second leg 108-2 to travel from the proximal end 120-2 of the second channel 102-2 to the distal end 122-2 of the second channel 102-2. The roller 110, extending between the leg components 108, is rolled along the bottom 114 of the body of water from the proximal end 120 to the distal end 122. The motors 106 can be reversed when the roller 110 reaches the distal end 122 such that it rolls back to the proximal end 120. This reciprocative movement can be repeated as desired and/or scheduled. Synchronization of the motors 106 described herein can be performed via a timing device, one or more positional switches, or by another suitable mechanism.

FIG. 3 is another overhead view of a dock-based weed control system 100 installed on a dock system in accordance with a number of embodiments of the present disclosure. The dock system illustrated in FIG. 3 includes a first dock section 112-1 substantially parallel to a second dock section 112-2, in addition to a number of other dock sections 113. The sections 113 can provide mooring, tie-up, and/or hoist locations for watercraft.

As with the example previously described in connection with FIG. 2, the example system 100 illustrated in FIG. 3 includes the first dock section 112-1 substantially parallel to the second dock section 112-2 (e.g., within 10 degrees of parallel). Reciprocative translation of the brackets (not illustrated in FIG. 3) causes the roller 110 to render a substantially rectangular area of weed control 124. This area 124 is defined by a length 126 of the roller 110 and a length 128 of the first and second channels (not illustrated in FIG. 3).

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and methods are used. Therefore, the scope of one or more embodiments of the present disclosure should be determined with reference to the appended claims, along with the full range of equivalents to which such claims are entitled.

As used herein, “a number of” something can refer to one or more of such things. As will be appreciated, elements shown in the various embodiments herein can be added, exchanged, and/or eliminated so as to provide a number of additional embodiments of the present disclosure.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A system, comprising:
a channel configured to extend along a dock section, the channel having a proximal end and a distal end;
a bracket configured to reciprocatively translate along the channel between the proximal end and the distal end;
a motor configured to drive the reciprocal translation of the bracket;
a leg component connected to the bracket; and
a roller connected to a bottom end of the leg component.

2. The system of claim 1, including a spring configured to apply a downward force to the roller.

3. The system of claim 1, wherein the leg component includes a weight.

4. The system of claim 1, wherein the leg component is slidably connected to the bracket.

5. The system of claim 4, wherein the leg component is configured to slide vertically responsive to an upward force applied by the roller to the bottom end of the leg component.

6. The system of claim 1, wherein the roller includes a plurality of fins extending radially outward from an axis of the roller.

7. The system of claim 1, including another motor configured to drive the reciprocal translation of the bracket.

8. The system of claim 7, wherein the motor is located at the proximal end of the channel, and wherein the other motor is located at the distal end of the channel.

9. The system of claim 8, including a controller configured to receive inputs to control operations of the motor.

10. The system of claim 9, wherein the controller is configured to receive inputs from a mobile device.

11. A method, comprising:
providing a first channel extending along a first dock section, the first channel having a first bracket therein;
providing a second channel extending along a second dock section substantially parallel to the first channel, the second channel having a second bracket therein;
providing a first leg component extending downward from the first bracket;
providing a second leg component extending downward from the second bracket; and
simultaneously causing:
the first bracket and the first leg to travel from a proximal end of the first channel to a distal end of the first channel; and
the second bracket and the second leg to travel from a proximal end of the second channel to a distal end of the second channel,
such that a roller extending between a bottom end of the first leg component and a bottom end of the second leg component rolls across a portion of a bottom of a body of water.

12. The method of claim 11, wherein a depth of the roller within the body of water varies according to a slope of the bottom of the body of water.

13. The method of claim 11, wherein the method includes:
providing a first motor configured to drive the travel of the first bracket; and
providing a second motor configured to drive the travel of the second bracket.

14. The method of claim 13, wherein the method includes simultaneously causing:
the first bracket and the first leg to travel from the proximal end of the first channel to the distal end of the first channel; and
the second bracket and the second leg to travel from the proximal end of the second channel to the distal end of the second channel,
such that the roller rolls across the portion of the bottom of the body of water at a first speed.

15. The method of claim 14, wherein the method includes simultaneously causing:
the first bracket and the first leg to travel from the proximal end of the first channel to the distal end of the first channel; and
the second bracket and the second leg to travel from the proximal end of the second channel to the distal end of the second channel,
such that the roller rolls across the portion of the bottom of the body of water at a second speed responsive to an adjustment made to the first motor or the second motor.

16. A system, comprising:
a first channel extending along a first dock section;
a second channel extending along a second dock section and substantially parallel to the first channel;
a first bracket configured to reciprocatively translate between a proximal end of the first channel and a distal end of the first channel;
a second bracket configured to reciprocatively translate between a proximal end of the second channel and a distal end of the second channel;
a first motor configured to drive the reciprocal translation of the first bracket;
a second motor configured to drive the reciprocal translation of the second bracket;
a first leg component connected to the first bracket;
a second leg component connected to the second bracket; and
a roller extending between the first leg component and the second leg component.

17. The system of claim 16, including a timing device configured to synchronize the reciprocal translation of the first bracket with the reciprocal translation of the second bracket.

18. The system of claim 16, including:
a third motor opposing the first motor on the first dock section and configured to drive the reciprocal translation of the first bracket; and
a fourth motor opposing the second motor on the second dock section and configured to drive the reciprocal translation of the second bracket.

19. The system of claim 16, wherein the roller is substantially perpendicular to each of the first and second dock sections.

20. The system of claim 19, wherein a substantially rectangular area of weed control is defined by a length of the roller and a length of the first and second channels.
